(19) United States
(12) Patent Application Publication
(10) Pub. No.: US 2009/0276422 A1
(43) Pub. Date: Nov. 5, 2009

(54) Apparatus for matching subject data sets with query data sets

(76) Inventor: Zdzislaw Wladyslaw Jaworski, Bromley (GB)

Correspondence Address: Mr. Paul Grandinetti;LEVY & GRANDINETTI, P.O.Box 18385, Washington, DC, 20036-8385, US

(21) Appl. No.: 12/453,129

(22) Filed: Apr. 29, 2009

(30) Foreign Application Priority Data
Apr. 29, 2008 (GB) GB-A-0807783.6

(51) Int. Cl. G06F 17/30

(52) U.S. Cl. 707/5; 707/E17.014

(57) ABSTRACT

Apparatus for matching subject data sets with a query data set comprising data input means, data processing means, data storage means and data presentation means,
in which the subject data sets comprise an identifier and one or more subject values derived from one or more definite integrals,
in which the one or more definite integrals comprise a variable value, a time based interval and a function which continuously decreases in the variable value over the time based interval,
in which at least the upper and lower limits of the time based interval are determined by raw subject data inputted into the apparatus via the data input means,
in which the subject data sets are stored in the data storage means,
in which the query data set comprises one or more requirements determined by raw query data inputted into the apparatus via the data input means,
in which the processing means is adapted to identify subject data sets comprising subject values which comply with one or more of the one or more requirements, and
in which the data presentation means is adapted to present the identifier of the identified subject data sets.

This invention relates to apparatus for matching subject data sets with query data sets, for use particularly, but not exclusively to match job seekers with potential employers via an Internet site.

There are several known types of Internet based apparatus which seek to bring job seekers and potential employers together, by identifying job seekers' experience and skills and matching them to the chosen requirements of potential employers.

However, in most cases the job seeker's experience and skill information are identified by searching the text of an uploaded CV for specific key words, and this is a highly inefficient way to identify suitable candidates because no attention is given to the context of the words or their real relevance. For example, when searching for a sales person with good experience of opening and closing deals, such systems will consider as suitable a candidate whose only experience of “opening and closing” has been opening and closing the retail store they worked in. Therefore potential employers using these systems are often presented with a large number of candidates who may or may not actually be suitable, all of whom have to be manually reviewed, which is very time consuming and wasteful.

In some cases a job seeker inputs their data via a normalised menu system, but such an arrangement relies on the job seeker and the potential employer using the menu choices in the same way. In addition, no account is taken of the real relevance of each particular choice. For example, in most examples a candidate can input that they have sales experience, but not the duration of this experience, or when it took place, which are very relevant considerations for a potential employer. Therefore, again the potential employer is presented with a number of candidates who may be suitable, but they must still be manually reviewed to ascertain this.

Therefore, known systems fail because they rely on the candidate to supply their information correctly, and they simply use filters to include or exclude candidates before presenting a long list of possibly suitable candidates for manual review. The object of the present invention is to provide apparatus which accurately assesses and ranks candidates' skill information.

Therefore, according to a first aspect of the present invention apparatus for matching subject data sets with a query data set comprises data input means, data processing means, data storage means and data presentation means, in which the subject data sets comprise an identifier and one or more subject values derived from one or more definite integrals, in which the one or more definite integrals comprise a variable value, a time based interval and a function which continuously decreases in the variable value over the time based interval, in which at least the upper and lower limits of the time based interval are determined by raw subject data inputted into the apparatus via the data input means, in which the subject data sets are stored in the data storage means, in which the query data set comprises one or more requirements determined by raw query data inputted into the apparatus via the data input means, in which the processing means is adapted to identify subject data sets comprising subject values which comply with one or more of the one or more requirements, and in which the data presentation means is adapted to present the identifier of the identified subject data sets.

With this arrangement the apparatus of the invention utilises a definite integral equation to give the resulting subject values a time based relevance. When the invention is used to rate job seekers' skills, this feature gives greater or lesser weight to previous job or skill experience according to its duration and how long ago it took place. As such, suitable candidates for a particular job can be rated with far greater accuracy than with known systems.

Preferably a plurality of predetermined and non-intersecting functions can be selectable for calculating the one or more definite integrals, and the particular function used can be determined by raw subject data inputted into the apparatus via the data input means. Therefore, a candidate can rate the previous job or skill experience on a scale of, say, 1 to 3, and the higher the rating the higher the value of the function used.

(The term “function” refers to the function in the definite integral equation, and in practice means the sum of a number of figures which are selected from a set sequence of figures according to the entered upper and lower limits of the interval. If the definite integral is considered as deriving from a graph, then the “function” is the graph line, and the “predetermined and non-intersecting functions” are a number of graph lines of different values one above the other. In practice there is no graph and no graph lines as such, and the different functions can be provided for by having a multiplication factor.)

In addition, a plurality of predetermined variable values each relating to different categories of subject matter can be selectable for calculating the one or more definite integrals, and the particular variable value used can be determined by raw subject data inputted into the apparatus via the data input means. Therefore, a candidate can choose from a number of different previous jobs or skills to match their own experience, and each one can have its own predetermined value characteristics, which can effect the outcome of the calculation.

(The term “variable value” refers to the variable in the definite integral equation, and the term “predetermined variable values” refers to set sequences of figures which are used to calculate the variable in the definite integral equation once the upper and lower limits of the interval and the function are known. If the definite integral is considered as deriving from a graph, then the “predetermined variable values” are the figures comprising the y axis. In practice these “predetermined variable values” will be scores which are weighted in favour of better job skills and experience, although it will be appreciated that to a certain extent the same end can be achieved by using a standard sequence of figures and altering the characteristics of the function instead. However, allowing for the variable values to be different provides greater flexibility.)

The subject data sets can comprise a plurality of subject values derived from a corresponding plurality of definite integrals, and each definite integral can comprise a different variable value relating to a particular category of subject matter. As such, a number of different factors can be included relating to a candidate's experience and skills. The one or more requirements of the query data set can simply comprise the presence in a subject data set of a subject value relating to a particular category of subject matter. As such, an employer can specify that certain skills are required, and those candidates which have those skills, to any degree, will be presented.

The processing means can be adapted to generate second subject data sets comprising only the subject values of a subject data set which are required by the requirements of the query data set. Therefore, the second subject data sets include only the values which are of interest to the potential employer, and not those which are not of interest to them. The processing means can be adapted to generate an overall subject score based on the second subject data sets, and the data presentation means can be adapted to present the overall subject score with each presented identifier. The data processing means can also be adapted to sort generated overall subject scores into value order, and to present the presented identifiers in said value order.

In order to allow for the upper and lower limits of the time base interval to be determined by users, the data presentation means can be adapted to present a start time choice and an end time choice for each variable value which is going to be used, and to allow a start time choice and an end time choice to be selected via the data input means.

In order to allow users to select the right variable values for them, the data storage means can comprise a database comprising a plurality of different categories of predetermined variable values, each comprising a plurality of predetermined variable values relating to a variant of a particular category of subject matter. In other words, basic categories of variable value, for example job type, can be made up of values relating to variants of such things, for example salesman, manager, computer programmer and so on. The variable values used to determine the subject values can be determined by raw subject data inputted into the apparatus via the data input means.

To provide for this functionality, each category of variable value can have a subject matter heading, and each variable value can have a category variant heading. The processing means can be adapted to match the subject matter headings with raw data inputted into the apparatus via the data input means, and the data presentation means can be adapted to present the matched subject matter headings and allow one or more to be selected via the data input means.

From there the processing means can be adapted to match category variant headings of the variable values in each of the categories of predetermined variable values selected by their subject matter headings, with further raw subject data inputted into the apparatus via the data input means, and the data presentation means can be adapted to present the matched category variant headings and allow one or more to be selected via the data input means. The processing means can use the particular predetermined variable values chosen by their category variant headings to generate the subject data sets. Therefore, the apparatus can use a text recognition system followed by a normalised menu system to allow a user to identify the predetermined variable values which relate to the experiences and skills they wish to input.

The data presentation means can be further adapted to present a relevance choice for each selected category variant heading, and to allow a relevance choice to be selected via the data input means. The particular predetermined function (or a particular multiplication factor) used to determine the subject value can be determined by the selected relevance choice.

In order to allow a potential employer to select their candidate requirements the processing means can be adapted to match subject matter headings with raw query data inputted into the apparatus via the data input means, and the data presentation means can be adapted to present the matched subject matter headings and allow one or more to be selected via the data input means.

From there the processing means can be adapted to match category variant headings of the predetermined variable values in each of the categories of predetermined variable values selected by their subject matter headings, with further raw query data inputted into the apparatus via the data input means, and the data presentation means can be adapted to present the matched category variant headings and allow one or more to be selected via the data input means. The data presentation means can be further adapted to use the selected category variant headings to generate the query data set. Therefore, the apparatus can use a text recognition system followed by a normalised menu system to allow a user to identify the types of experience and skills they require in a candidate.

In one version of the invention, once the data processing means has sorted the generated overall subject scores into value order, the processing means can be adapted to allow required value characteristics for each of the chosen subject values to be entered via the data input means. The required value can be a threshold value which must be exceeded, for example a value which relates to a number of years of job experience; or the required value could be an upper and a lower limit within which a subject value must be located, for example values relating to between 3 and 5 years of job experience. Therefore, an employer can filter the presented results if there are too many, or if their requirements are more defined.

The processing means can be adapted to generate third subject data sets comprising only the subject values of a subject data set which comprise these required value characteristics. Again, the processing means can be adapted to generate an overall subject score based on the third subject data sets, which can be sorted into value order and presented.

In an alternative arrangement to that described above, the original one or more requirements can comprise a required value characteristic in the first instance, so the second subject data sets can comprise only those subject values of a subject data set which comprise the required value characteristics. To facilitate this particular arrangement, once the data presentation means has presented category variant headings which match the further raw query data and allowed one or more to be selected via the data input means, the data presentation means can be adapted to allow a required value characteristic to be selected for each of the selected category variant headings, and the processing means can use the required characteristics to generate the query data set.

It will be appreciated that a system can be provided quite easily which can operate according to both of the two above described arrangements. The first arrangement ensures more candidates will be found at first, and allows them to be filtered down as desired, while the second arrangement applies one or more filters from the start, which can save time.

It will be appreciated that the apparatus of the invention can be put into effect in many technical ways, but in a preferred embodiment the apparatus can comprise a principal computer and a plurality of secondary computers connectable to the principal computer over the Internet. The principal computer can comprise the data processing means and the data storage means, and each secondary computer can comprise data input means and data presentation means. Each secondary computer can be adapted to access the principal computer over the Internet such that subject raw data, query raw data, subject matter heading selections, category variant heading selections, relevance choice selections and required value selections can be inputtable to the apparatus via the data input means of a secondary computer, and such that overall subject scores, matched subject matter headings, matched category variant headings, relevance choices and required value choices are presentable via the data presentation means of a secondary computer.

Therefore, the principal computer can belong to a service provider, and the secondary computers can be those of job seekers and potential employers who wish to access the system, either to place their details on it, or to seek the details of others.

The principal computer can comprise a data input means and a data presentation means, and the data processing means can be adapted to allow the predetermined functions and the predetermined variable values to be entered and adjusted via the data input means of the principal computer. Therefore, the service provider has the ability to set up the system as they see fit, and to adjust its workings to improve its functionality.

As referred to above, the present invention can be used to match any kind of subject data sets with a query data set, but in a preferred construction the subject data sets can comprise job candidate data sets, and the query data sets can comprise employer data sets.

The different predetermined categories of variable value can comprise job role, job skill and job type, and the predetermined variable values can relate to different job roles, different job skills and different job types respectively. The calculated subject values can comprise subjective job role, job skill and job type scores based on a pre-determined score scale, which scores are derived from the results of the definite integral equations.

The required values can comprise subjective required scores on said score scale for job role, job skill and job type.

The invention also includes a method of using apparatus as described above. Therefore, according to a second aspect of the present invention a method of using apparatus for matching subject data sets with a query data set as claimed in Claim 1, comprises the following steps:
i) Using the data input means to enter one or more variable values and one or more functions each relating to a variable value, into the data storage means,
ii) Using the data input means to enter the upper and lower limits of time based intervals, each relating to a variable value,
iii) Using the data processing means to generate definite integral equations based on each variable value, a function relating to each variable value and a time based interval relating to each variable value; solving said definite integral equations to generate one or more subject values; and forming said subject values into subject data sets,
iv) Storing the subject data sets in the data storage means,
v) Using the data input means to enter one or more requirements formed into query data sets,
vi) Using the data processing means to identify subject data sets comprising subject values which comply with one or more of the one or more requirements,
vii) Using the data presentation means to present the identifier of the identified subject data sets.

The invention can be performed in various ways, but one embodiment will now be described by way of example and with reference to the accompanying drawings, in which:

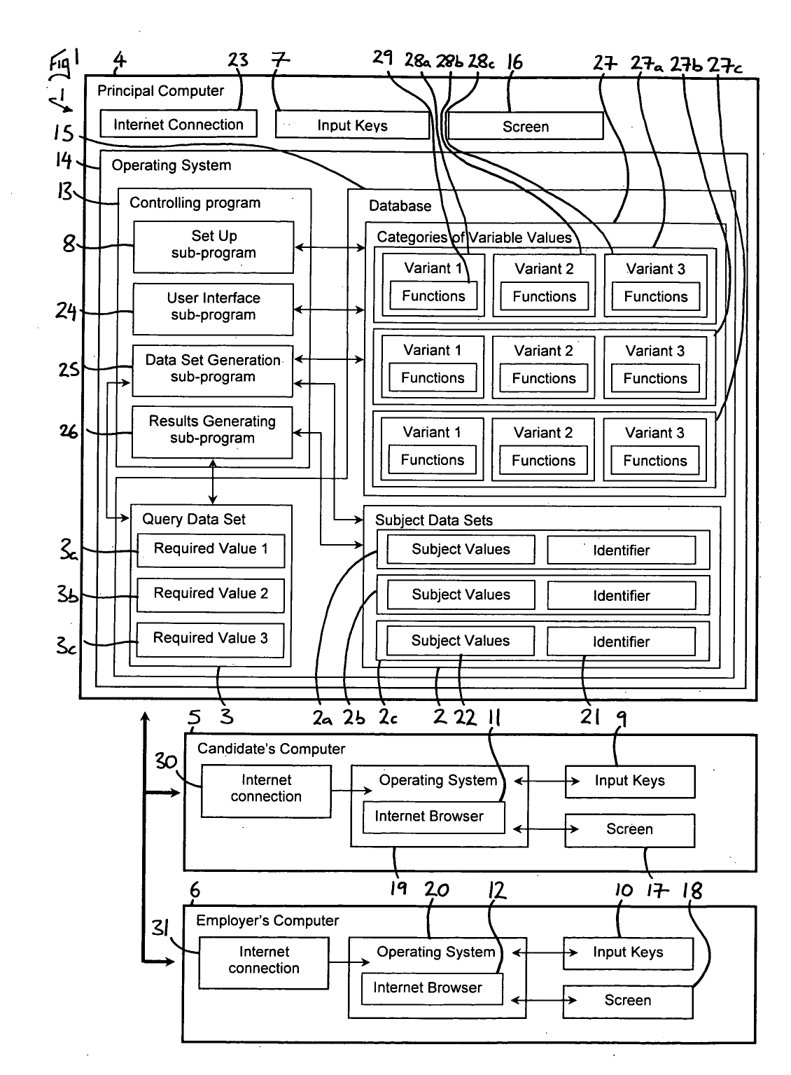

FIG. 1 is a diagrammatic view of apparatus according to the present invention;

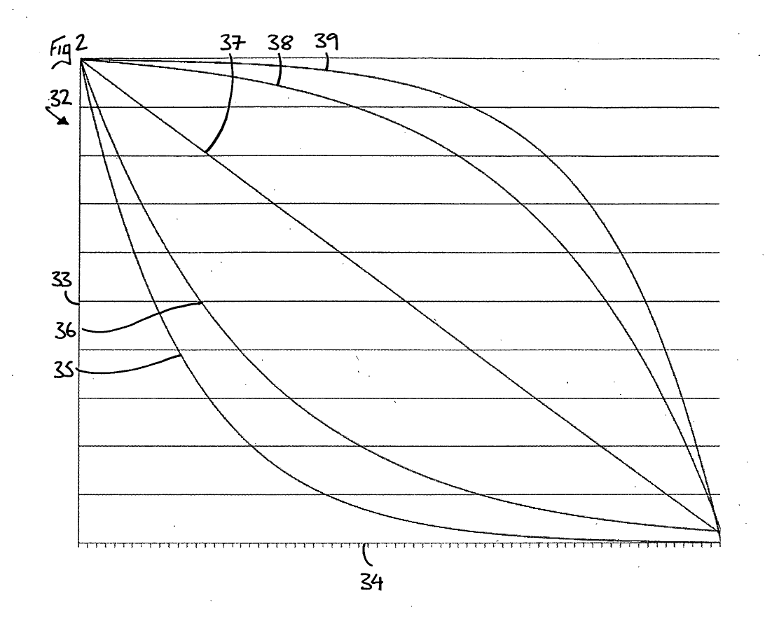

FIG. 2 is a graphical representation of a number of theoretical functions utilised by the apparatus shown in FIG. 1;

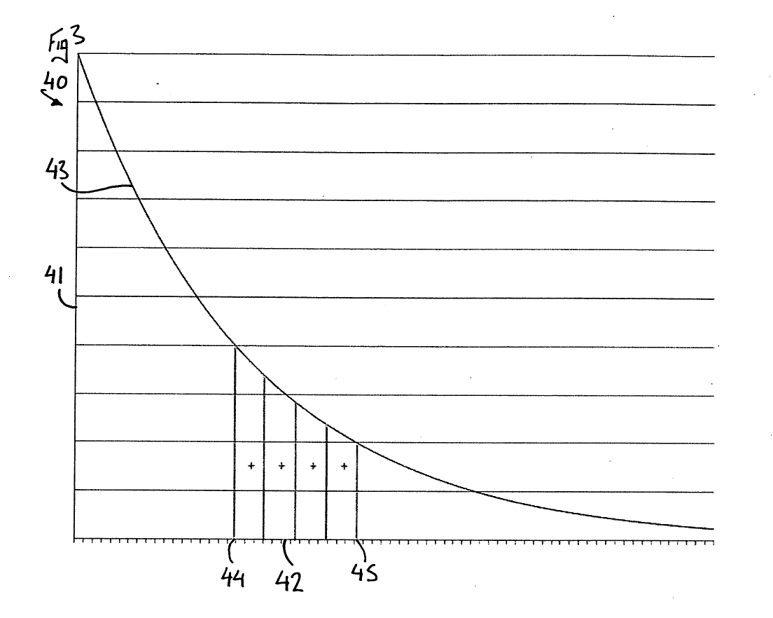

FIG. 3 is a graphical representation of a definite integral utilised by the apparatus shown in FIG. 1; and,

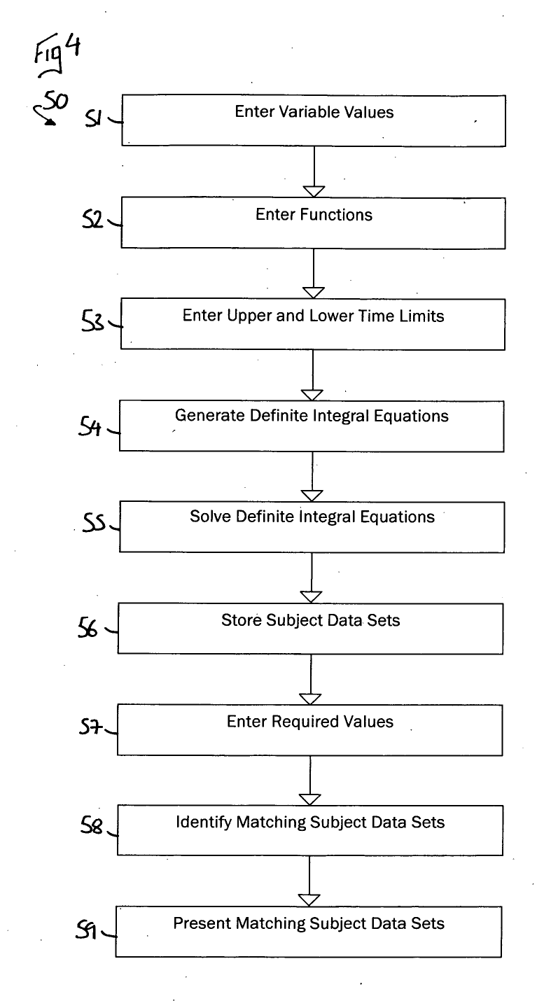

FIG. 4 is a flow chart showing the steps of a method of using the apparatus as shown in FIG. 1.

As shown in FIG. 1 apparatus 1 for matching subject data sets 2 with a query data set 3 comprises a principal computer 4 and secondary computers 5 and 6. The apparatus 1 as a whole comprises data input means in the form of input keys 7 and set up sub-program 8 provided as a part of the principal computer 4, and input keys 9 and 10 and Internet browser programs 11 and 12 provided as a part of the secondary computers 5 and 6. The apparatus 1 comprises data processing means in the form of controlling program 13, which is loaded onto the operating system 14 provided as a part of the principal computer 4, and data storage means in the form of database 15 also provided as a part of the principal computer 4. The apparatus 1 as whole also comprises data presentation means in the form of screen 16 and the set up sub-program 8 provided as a part of the principal computer 4, and screens 17 and 18 and Internet browser programs 11 and 12 provided as a part of the secondary computers 5 and 6.

(The controlling program 13 performs the general processing actions performed by the apparatus 1 herein described, however it will be appreciated that single sub-programs interact with other programs on the computer on which they operate, and with other programs on computers which are connected to the computer on which they operate, in order to perform their functions. Therefore, the term “data processing means” as used herein is intended to apply to any part of the principal computer 4 or the secondary computers 5 and 6 which performs any processing function as a part of the below described operation of the apparatus 1, which could include other parts of the operating system 14, other parts of the operating systems 19 or 20 provided as a part of the secondary computers 5 and 6, or any programs or sub-programs loaded thereon (not shown). Further, it will be appreciated that FIG. 1 is a very simple diagram intended to show the basic operating features of the computers 4, 5 and 6, and for ease of explanation these functions are divided between a small number of illustrated sub-programs. However, it will be appreciated that in practice such clearly defined boundaries may not be appropriate, and FIG. 1 is not intended to be understood as anything other than a diagrammatic view of the various features of the invention, and how they interact with one another.)

FIG. 1 shows only three subject data sets 2a, 2b and 2c for ease of explanation, but it will be appreciated that in practice this number will be far higher. In each case, the subject data sets 2a to 2c comprise an identifier 21 and subject values 22 derived from one or more definite integrals.

As described further below, the one or more definite integrals used to generate the subject values 22 comprise a variable value, a time based interval and a function which continuously decreases in the variable value over the time based interval. At least the upper and lower limits of the time based interval are determined by raw subject data inputted into the apparatus 1 via the data input means, which in this case would be input keys 9 and Internet browser 11 on the candidate's computer 5.

The subject data sets 2a to 2c are stored in the database 15. The query data set 3 comprises one or more requirements, which in this case comprise three required values 3a, 3b and 3c, and which are determined by raw query data inputted into the apparatus 1 via the data input means, which in this case would be input keys 10 and Internet browser 12 on the employer's computer 6. These required values comprise either thresholds relating to particular subject value types, or upper and lower limits for particular subject values.

As described further below the processing means (13) is adapted to identify subject data sets 2a to 2c comprising subject values 22 which comply with one or more of the one or more required values 3a to 3c, which is to say their value exceeds a given threshold or lies with an upper or lower limit, and the data presentation means, which in this case would be the screen 18 and the Internet browser 12 of the employer's computer, is adapted to present the identifier 21 of the identified subject data sets 2a to 2c.

The principal computer 4 is of a known construction, and comprises the operating system 14, which is also of a known type. As well as the input keys 7 and the screen 16, the principal computer 4 comprises an Internet connection 23, which comprises for example a modem and a connection to an Internet enabled telephone line.

The controlling program 13 is new and is constructed for the purposes of putting the present invention into effect. As referred to above, for the purposes of explanation the controlling program 13 is shown to comprise merely four sub-programs, however in practice such clearly defined definitions may not be appropriate. The man skilled in the art will be able to write computer code which will put the present invention into effect in any of the known ways using their common general knowledge of the field.

However, for the purpose of explanation, the controlling program 13 comprises set up sub-program 8, user interface sub-program 24, data set generation sub-program 25 and results generating sub-program 26.

FIG. 1 shows the apparatus 1 already set up and in the middle of being used, and as such subject data sets 2a to 2c are already stored in the database 15, and one query data set 3 is also stored in the database 15. In addition to this, categories of variable values 27 are also stored in the database 15. There are three categories, 27a, 27b and 27c, and each one comprises three variants, each of which has a plurality of functions associated with it. In the case of category 27a, there are variants 28a, 28b and 28c, each of which has a plurality of functions 29 (or one function and a number of multiplication factors) associated with it. (It will be appreciated that all the variants are different to one another, but for ease of explanation only variants 28a to 28c are given reference numbers. Likewise, all the functions are different to one another, but only functions 29 are given a reference number.)

As such, two of the basic features of a definite integral equation are already stored in the database 15, being variable values, and functions relating thereto.

Both the candidate's computer 5 and the employer's computer 6 are of a known construction, and comprises operating systems 19 and 20 respectively, which are also of a known type. As well as the input keys 9 and 10 and the screens 17 and 18 the candidate's computer 5 and the employer's computer 6 comprise Internet connections 30 and 31 respectively, which comprises for example modems and connections to Internet enabled telephone lines.

In use the apparatus 1 operates as follows. The controlling program 13 is loaded onto the principal computer 4, and a service provider must set up the apparatus 1 for use. The user interface sub-program 24 allows the service provider to access the setup sub-program 8, and program the various categories of variable values 27a to 27c, the characteristics of each variant 28a to 28c, and the characteristics of each of the functions 29.

In the present case, the three categories of variable values 27a to 27c comprise job role, job skill and job type. Each variant 28a to 28c comprises a particular type of job role, job skill and job type. For example, category 27a comprises job role, and variants 28a to 28c comprise types of job role, for example staff management, sales, secretarial work and so on. (It will be appreciated that while only three variants 28a to 28c are shown in FIG. 1, the actual number could be far higher to accommodate a greater variety of job roles.)

For each variant 28a to 28c the actual value scale, from which the variable value is drawn when the definite integral equation is created, can be set. For example, for staff management, the value scale can comprise higher values than those for secretarial work. The manner in which these variable values are arranged is entirely at the discretion of the service provider. For each variant 28a to 28c the characteristics of the different functions 29 can also be set, and again this is entirely at the discretion of the service provider.

FIGS. 2 and 3 show graphical representations of the process referred to above. FIG. 2 shows a graph 32 with a y value axis 33 and an x time axis 34. On the graph 32 are shown five different graph lines 35, 36, 37, 38 and 39, which represent different types of possible function. In each case the graph lines always decrease in value over time, but the value of the functions at different time points is different. For example, graph line 35 decreases in value over time at a high rate initially, then at a lower rate, while graph line 37 decreases at a constant rate, and graph line 39 decreases in value at a low rate initially then at a higher rate.

If the service provider decides that a particular job role has a high importance, then the values on the y axis can be high, for example from 25 to 100, rather than from 0 to 75. Then, if the service provider decides that this particular job role has a lesser degree of relevance the longer ago it was performed, a function akin to a graph line like 35 or 36 can be used. Conversely, if the service provider decides that this particular job role has a high degree of relevance even if it was performed some time ago, a function akin to a graph line like 38 or 39 can be used.

For each variable value a number of functions are set up and become selectable. Graphically speaking these functions would be non intersection graph lines, one above the other. (If a simple multiplication factor is used, then the graph lines would mirror one another in shape, but it will be appreciated that if the multiplication factor were given a time frame, then the graph lines could be different shapes.) As such, the function at a particular time point is greater or lesser depending on the graph line used. This allows a relevance weighting to be given to each job role by the candidate. For example, should the candidate rate their previous job role experience highly, then the higher of the functions or graph lines would be used, and visa versa.

It will be appreciated that in practice the principal computer 4 deals in figures rather than graphs, and as such the “functions” referred to above are not graph lines, but sequences of figures each of which are the function of a variable value at a particular time point.

Once all the categories of variable values 27a to 27c and all the variants 28a to 28c and their functions 29 are set, the apparatus 1 can be used by candidates and employers.

Each candidate accesses the principal computer 4 over the Internet, and uses the user interface sub-program 24 and their own Internet browser 11 to enter their data. In the case of FIG. 1, a candidate uses candidate's computer 5 to do this, however it will be appreciated how this arrangement can be duplicated ad infinitum.

Initially the candidate is asked to enter various personal details about themselves, for example their name, address and contact information. Some or all of this entered data is used to generate the identifier 21 for that candidate's subject data set.

The candidate is then asked to enter any job roles they have performed into a text box, which they do using the input keys 9. The user interface sub-program 24 then matches the entered text with category variant headings associated with each variant 28a to 28c. The matches are shown on the screen 17, and the candidate is asked to select those which are relevant. The same process is performed for job skill and job type, until a particular set of variants have been selected from those in the database 15. (The invention allows for the same text matching and selecting process to be performed to identify the particular categories 27a to 27c from which the variants 28a to 28c are to be chosen. However, in the particular case information on job role, job skill and job type is mandatory, so each category is simply presented automatically.)

The candidate is then asked to enter a start time and an end time for each of the selected category variant headings. This entered data is used to determine the upper and lower limits of the time based interval in each definite integral equation.

The candidate is then asked to select a relevance choice for each selected category variant heading, which in this case is a high, medium or a low rating. This entered data is used to determine which of three functions available for each variable value is used.

Once this data is entered the data set generation sub-program 25 uses the entered data, and that stored in the category of variable values 27, to create definite integral equations, and to solve the equations to produce results. FIG. 3 is a graphical representation of how such a definite integral equation is reached. FIG. 3 shows a graph 40 with a y value axis 41 with value scores relating to a job role selected by the candidate, and an x time axis 42. On the graph 40 is a graph line 43 which represents the function (either high, medium or low) as selected by the candidate. Also shown on the graph 40 is a start time point 44 and an end time point 45 as also selected by the candidate for this particular job role. The definite integral in this case is therefore the area under the graph line 43 between the start time point 44 and the end time point 45.

Mathematically, the definite integral equation is denoted as:

$${\int }_{Start Date}^{End Date} f ( x )$$

As the function is in fact just a sequence of figures, the result of this equation is simply equal to all the figures between the start date and the end date. In addition, the three different functions, which graphically would be three different non-intersecting graph lines, are most easily computable as a multiplying factor for a single sequence of figures. For example, for low the result of the above equation would be multiplied by 1, for medium by 1.5 and for high by 2.

This process is repeated for each of the job roles, job skills and job types that the candidate selected, to produce a set of subject values 22, which are then stored in the database 15 along with the candidate's identifier 21. Each subject value 22 is identified by the particular job role, job skill or job type variable value which was used to generate it. At this point the subject values are converted into round scores on a predetermined score scale, for example from 0 to 100.

This process is performed every time a candidate uses the system, and in practice a very large number of subject data sets 2 will be stored in the database 15, although for ease of explanation only three 2a, 2b and 2c are shown in FIG. 1. The apparatus 1 is now ready to be used by employers seeking candidates.

Each employer accesses the principal computer 4 over the Internet, and uses the user interface sub-program 24 and their own Internet browser 12 to enter their data. In case of FIG. 1, an employer uses employer's computer 6 to do this, however it will be appreciated how this arrangement can be duplicated ad infinitum.

The employer is asked to enter any job roles they want their candidates to have performed into a text box, which they do using the input keys 10. The user interface sub-program 24 then matches the entered text with category variant headings associated with each variant 28a to 28c. The matches are shown on the screen 18, and the employer is asked to select those which are relevant. The same process is performed for job skill and job type, until a particular set of variants have been selected from those in the database 15. (The invention allows for the same text matching and selecting process to be performed to identify the particular categories 27a to 27c from which the variants 28a to 28c are to be chosen. However, in the particular case information on job role, job skill and job type is mandatory, so each category is simply presented automatically.)

The employer is then asked to enter a required value for each of the selected category variant headings, which required value is a threshold score on the above mentioned scale of 1 to 100. Alternatively, or in addition to selecting a single threshold score on this scale, the employer can select a region on the score scale, for example in the upper quarter or lower quarter and so on, which allows for an employer to filter out those who may be over qualified in a particular skill. The data set generation sub-program 25 then compiles all this inputted data and generates the query data set 3, which is stored in the database 15. In practice numerous required values can make up the query data set 3, but for ease of explanation only the 3a, 3b and 3c are shown in FIG. 1.

Once this process is complete the results generating sub-program 26 searches through all the subject data sets 2a to 2c to locate any subject value 22 which exceeds a required value 3a to 3c, (or falls within upper and lower threshold limits). For each subject data set 2a to 2c which comprises one or more matches, those matches are compiled together to create second subject data sets (not shown). Therefore, the second subject data sets comprise only the subject values 22 which are of interest to the employer. The matching subject values 22 are added together in each case to produce an overall subject score, and the candidates are ranked in score order. The results list, including the overall score and the matching separate subject value scores, are then presented to the employer on their screen 18, along with each candidate's identifier information 21. Each candidate's subject values 22 which did not match the employer's required values are also available to the employer should he wish to see them.

The employer can perform the above process time and again to narrow down their search if the results they receive are too numerous or unsatisfactory.

The apparatus 1 can also operate in a slightly different way if desired, to increase the potential number of initial results. Instead of the employer entering a required value for each of the selected category variant headings in the first instance, as described above, the query data set 3 is simply left as a list of category variant headings. The results generating sub-program 26 then searches through all the subject data sets 2a to 2c to locate any subject value 22 which is present in the query data set 3. Again, only the subject values which match are used, and added together to produce an overall subject score. The results list can therefore include more candidates that if required values were used to filter some of them out.

Once the results list has been produced, the employer can then be asked to enter a required value for each of the category variant headings they earlier selected, which required value can be a threshold score or a region on a score scale, as referred to above. This allows an employer to filter out those on the results list who are under or over qualified in a particular skill, if desired. If this option is taken, the results generating sub-program 26 searches through the subject data sets in the results list and generates a third subject data sets comprising only the subject values of a subject data set which comprise these required values, and presents a filtered results list. The employer can perform this process time and again to narrow down their search.

The apparatus 1 can be provided with many other known features to assist its operation. For example, the apparatus 1 can incorporate an internal communication system, for example an email system, to allow employers to contact candidates they like. In addition, an activity log can be kept in the database 15, so the service provider can access information on the usage of the apparatus 1. The activity log can include all the generated subject data sets 2 and query data sets 3, as well as information on the identities of the candidates and employers using the system. As with other known services provided on the Internet, the apparatus 1 can also incorporate a membership system in which both candidates and employers must create an ID and log in and out of the system to use it. Alongside this, the apparatus 1 can also incorporate any of the known payment systems so the candidates and/or the employers can pay for the use of the apparatus 1.

The apparatus 1 can also incorporate other known job site features, for example the ability to allow CVs to be uploaded in any of the already known ways referred to above. As such, once candidates have been identified by employers in the manner described above, the employers can access those candidate's actual CVs to learn more about them. (The identifier 21 could be adapted to include this data, or a link to it.)

The set up sub-program 8 is adapted to allow the service provider to amend any of the variable values 27 and their functions 29 to improve the functionality of the system in response to user feedback. For example, further variants 27a to 27c could be added if either candidates or employers identify any omissions, while duplicate or redundant variants can be removed. Further, the actual variable values 27a to 27c and the functions 29 themselves can be adjusted if it becomes apparent that certain job roles, skills and types are too heavily weighted or otherwise.

As referred to above, the present invention also includes a method of using apparatus for matching subject data sets with a query data set as claimed in Claim 1, and the above description of apparatus 1 provides full support for the method.

However, to assist with the understanding of the claimed method, FIG. 4 illustrates a flow diagram 50 relating to the basic method of the invention.

At a first step 51 the service provider enters all the categories of variable values 27 into the database 15, and at a second step 52 they enter all the different functions 29.

At a third step 53 the candidate enters the start and end times of all their previous job roles, job skills and job types, after identifying them from the category variant headings as referred to above.

At fourth and fifth steps 54 and 55 the data set generation sub program 25 creates the various definite integral equations from all the entered and stored data, and solves those equations to produce the subject data sets 2, which are stored in the database 15 at a sixth step 56.

At a seventh step 57 an employer enters their data to generate the query data set 3 and its various required values 3a to 3c. (As referred to above these could be threshold values, upper and lower limits, or even just the required presence of particular subject values.)

As an eighth step 58 the results generating sub-program 26 operates to locate subject data 2a to 2c sets with subject values 22 which comply with the required values 3a to 3c, and at a ninth step 59 these results are presented to the employer along with the identifiers 21.

It will be appreciated that the above described method conforms to the present invention in only the broadest terms, and all the other more detailed steps and features referred to above can be readily introduced to the illustrated method.

Therefore, the apparatus 1 utilises definite integral equations to give the resulting subject values a time based relevance. As such, when a candidate's experiences took place and their duration are fully accounted for in the overall score. Further, the apparatus allows the service provider to weight the resulting subject values in favour of more desirable experience, which takes the emphasis away from the candidates themselves, who may otherwise attempt to exaggerate or place undue emphasis on certain past experiences. As such, suitable candidates for a particular job are rated with far greater accuracy than with known systems.

1. Apparatus for matching subject data sets with a query data set comprising data input means, data processing means, data storage means and data presentation means,
in which the subject data sets comprise an identifier and one or more subject values derived from one or more definite integrals,
in which the one or more definite integrals comprise a variable value, a time based interval and a function which continuously decreases in the variable value over the time based interval,
in which at least the upper and lower limits of the time based interval are determined by raw subject data inputted into the apparatus via the data input means,
in which the subject data sets are stored in the data storage means,
in which the query data set comprises one or more requirements determined by raw query data inputted into the apparatus via the data input means,
in which the processing means is adapted to identify subject data sets comprising subject values which comply with one or more of the one or more requirements, and
in which the data presentation means is adapted to present the identifier of the identified subject data sets.

2. Apparatus as claimed in claim 1 in which a plurality of predetermined and non-intersecting functions are selectable for calculating the one or more definite integrals, and the particular function used is determined by raw subject data inputted into the apparatus via the data input means.

3. Apparatus as claimed in claim 2 in which a plurality of predetermined variable values each relating to different category of subject matter are selectable for calculating the one or more definite integrals, and the particular variable value used is determined by raw subject data inputted into the apparatus via the data input means.

4. Apparatus as claimed in claim 3 in which the subject data sets comprise a plurality of subject values derived from a corresponding plurality of definite integrals, in which each definite integral comprises a different variable value relating to a particular category of subject matter, and in which the one or more requirements comprise the presence in a subject data set of a subject value relating to a particular category of subject matter.

5. Apparatus as claimed in claim 4 in which the processing means is adapted to generate second subject data sets comprising only the subject values of a subject data set which are required by the requirements of a query data set, in which the processing means is adapted to generate an overall subject score based on the second subject data sets, and in which the data presentation means is adapted to present the overall subject score with each presented identifier.

6. Apparatus as claimed in claim 5 in which the data processing means is adapted to sort generated overall subject scores into value order, and in which the data presentation means is adapted to present the presented identifiers in said value order.

7. Apparatus as claimed in claim 6 in which the data presentation means is adapted to present a start time choice and an end time choice for each variable value and to allow a start time choice and an end time choice to be selected via the data input means, and in which the upper and lower limits of the time based interval are determined by the selected start time choice and end time choice.

8. Apparatus as claimed in claim 7 in which the data storage means comprises a database comprising a plurality of different categories of predetermined variable values, each comprising a plurality of predetermined variable values relating to a variant of a particular category of subject matter.

9. Apparatus as claimed in claim 8 in which each category of predetermined variable value has a subject matter heading, in which each predetermined variable value has a category variant heading,
in which the processing means is adapted to match subject matter headings with raw subject data inputted into the apparatus via the data input means,
in which the data presentation means is adapted to present the matched subject matter headings and allow one or more to be selected via the data input means,
in which the processing means is adapted to match category variant headings of the predetermined variable values in each of the categories of predetermined variable values selected by their subject matter headings, with further raw subject data inputted into the apparatus via the data input means,
in which the data presentation means is adapted to present the matched category variant headings and allow one or more to be selected via the data input means and
in which the processing means uses the particular predetermined variable values selected by their category variant headings to generate the subject data sets.

10. Apparatus as claimed in claim 9 in which the data presentation means is adapted to present a relevance choice for each selected category variant heading and allow a relevance choice to be selected via the data input means, and in which the particular predetermined function used to determine the subject value is determined by the selected relevance choice.

11. Apparatus as claimed in claim 10, in which the processing means is adapted to match subject matter headings with raw query data inputted into the apparatus via the data input means,
in which the data presentation means is adapted to present the matched subject matter headings and allow one or more to be selected via the data input means,
in which the processing means is adapted to match category variant headings of the predetermined variable values in each of the categories of predetermined variable values selected by their subject matter headings, with further raw query data inputted into the apparatus via the data input means,
in which the data presentation means is adapted to present the matched category variant headings and allow one or more to be selected via the data input means,
in which the processing means uses the selected category variant headings to generate the query data set.

12. Apparatus as claimed in claim 11 in which once the data processing means has sorted the generated overall subject scores into value order, the processing means is adapted to allow required value characteristics of subject values relating to a particular category of subject matter to be entered via the data input means, in which the processing means is adapted to generate third subject data sets comprising only the subject values of a subject data set which comprise the required value characteristic, in which the processing means is adapted to generate an overall subject score based on the third subject data sets, in which the data processing means is adapted to sort generated overall subject scores into value order, and in which the data presentation means is adapted to present the presented identifiers in said value order.

13. Apparatus as claimed in claim 11 in which the one or more requirements each comprise a required value characteristic of a subject value relating to a particular category of subject matter, in which the second subject data sets comprise only the subject values of a subject data set which comprise the required value characteristic.

14. Apparatus as claimed in claim 13, in which once the data presentation means has presented category variant headings which match the further raw query data and allowed one or more to be selected via the data input means, the data presentation means is adapted to allow a required value characteristic to be selected for each of the selected category variant headings, and in which the processing means uses the required characteristics to generate the query data set.

15. Apparatus as claimed in claim 14, in which the apparatus comprises a principal computer and a plurality of secondary computers,
in which any secondary computer is connectable to the principal computer over the Internet,
in which the principal computer comprises the data processing means and the data storage means,
in which each secondary computer comprises data input means and data presentation means,
in which each secondary computer is adapted to access the principal computer over the Internet such that subject raw data, query raw data, subject matter heading selections, category variant heading selections, relevance choice selections and required value selections are inputtable to the apparatus via the data input means of a secondary computer, and such that overall subject scores, matched subject matter headings, matched category variant headings, relevance choices and required value choices are presentable via the data presentation means of a secondary computer.

16. Apparatus as claimed in claim 15 in which the principal computer comprises a data input means and a data presentation means and in which the data processing means is adapted to allow the predetermined functions and the predetermined variable values to be entered and adjusted via the data input means of the principal computer.

17. Apparatus as claimed in claim 1 in which the subject data sets comprise job candidate data sets, and in which the query data sets comprise employer data sets.

18. Apparatus as claimed in claim 17 when dependent on any of claims 9 to 16 in which the different predetermined categories of variable value comprise job role, job skill and job type, in which the predetermined variable values relate to different job roles, different job skills and different job types respectively, and in which the calculated subject values comprise subjective job role, job skill and job type scores based on a pre-determined score scale, which scores are derived from the definite integrals.

19. Apparatus as claimed in claim 18 in which the required values comprise subjective required scores on said score scale for job role, job skill and job type.

20. (canceled)

21. A method of using apparatus for matching subject data sets with a query data set as claimed in claim 1, in which the method comprises the following steps:
i) Using the data input means to enter one or more variable values and one or more functions each relating to a variable value, into the data storage means,
ii) Using the data input means to enter the upper and lower limits of time based intervals, each relating to a variable value,
iii) Using the data processing means to generate definite integral equations based on each variable value, a function relating to each variable value and a time based interval relating to each variable value; solving said definite integral equations to generate one or more subject values; and forming said subject values into subject data sets,
iv) Storing the subject data sets in the data storage means,
v) Using the data input means to enter one or more requirements formed into query data sets,
vi) Using the data processing means to identify subject data sets comprising subject values which comply with one or more of the one or more requirements,
vii) Using the data presentation means to present the identifier of the identified subject data sets.

22. (canceled)
